(19) United States
(12) Patent Application Publication
(10) Pub. No.: US 2004/0139181 A1
(43) Pub. Date: Jul. 15, 2004

(54) Network programming language structure

(76) Inventors: Steve Baril, St-Elzear (CA); Martin Pilote, Les Saules (CA)

Correspondence Address: Ms. Diane Dunn McKay, MATHEWS, COLLINS, SHEPHERD & McKAY, P.A., Suite 306, 100 Thanet Circle, Princeton, NJ, 08540-3674, US

(21) Appl. No.: 10/705,075

(22) Filed: Nov. 10, 2003

Related U.S. Application Data
(60) Provisional application No. 60/425,121, filed on Nov. 8, 2002.

(51) Int. Cl. G06F 15/177; G06F 15/173

(52) U.S. Cl. 709/221; 709/224

(57) ABSTRACT

The present invention discloses a method and a network for interconnecting a plurality of electronic devices for their configuration and control, the network comprising at least one of the plurality of electronic devices being a local node including a controller, a memory and at least one local virtual variable having a value representative of a state of the local node, the local virtual variable being stored in the memory of the local node, the non-selected electronic devices being remote nodes including a controller and a memory, the memory having stored therein at least one remote virtual variable having a value representative of a state of the remote node, the remote virtual variable being reported by the controller of the remote node on the network in response to a change in the value of said remote virtual variable, and at least one action being stored in the memory of the local node for execution by the controller of the local node, the action using the local virtual variable and the remote virtual variable, wherein the controller of the local node is so configured as to execute the action stored in the memory of the local node in response to the reporting of the remote virtual variable, the action changing the value of the local virtual variable and modifying the state of the local node according to the value of the local virtual variable.

### CROSS-REFERENCE TO RELATED APPLICATIONS

The present application claims the benefits of U.S. provisional patent application No. 60/425,121 filed Nov. 8, 2002, which is hereby incorporated by reference.

### TECHNICAL FIELD

The present invention relates generally to configuring and controlling electronic devices connected to a network.

### BACKGROUND

With the advent of computer technology, the heart of any computer is the microprocessor or microcontroller. The addition of these key parts to any device or appliance can convert them into small computers. Software code integrated into the microprocessors enables a device or appliance to perform automated tasks without external control. These components that are integrated into pre-existing machines are often referred to as “embedded systems”. Along with microprocessors, other hardware components such as memory can add further robustness to otherwise simple machines. Physical space available in these pre-existing machines is often limited however, so whatever storage is available must be used efficiently.

Connecting many embedded systems on a network allows for communication between the embedded systems. Computer networking focuses on having a number of processors communicate and share information with one another, as well as the utilization of such systems by remote devices. Taking it a step further, embedded systems in communication with other systems may be thought of as a distributed data processing system. In such a distributed system, the results of embedded system networking lead to the design of applications systems. Information gathered from one system on the network could affect the states of other systems. For example, the closing of a light switch may initiate the lowering of a television set's volume. The software in the microprocessor of one embedded system often relies on knowledge of other system's states to perform certain tasks.

The software embedded in each embedded system or device must be structured in such a way to facilitate inter-network communication. Current network programming structures use compiler based languages for the source program and compilers to convert the source program into machine code. While these programming structures allow for communicating and controlling information, the format is complex and requires additional memory. Storage space is already limited so the requirement for extra storage space can increase costs. In the field, compiler based programming languages are generally difficult to configure and are not readily adaptable device or network changes.

Accordingly, it is an object of the present application to obviate or mitigate some or all of the above disadvantages.

### SUMMARY

In one aspect of the present invention, there is provided a method for configuring and controlling a plurality of interconnected electronic devices defining a network, said method comprising:

selecting at least one of said plurality of electronic devices as a local node;

defining at least one local virtual variable having a value representative of a state of said local node;

defining the non-selected devices as remote nodes; each remote node having at least one remote virtual variable having a value representative of a state thereof, each said remote virtual variable being reported on said network in response to a change in said value of said remote virtual variable;

providing said local node with at least one action using said local virtual variable and said remote virtual variable;

executing said action in response to said reporting of said remote virtual variable, said action changing said value of said local virtual variable; and

modifying said state of said local node according to said value of said local virtual variable.

In another aspect of the present invention, there is further provided a network interconnecting a plurality of electronic devices for their configuration and control, said network comprising:

at least one of said plurality of electronic devices being a local node including a controller, a memory and at least one local virtual variable having a value representative of a state of said local node; said local virtual variable being stored in said memory of said local node;

the non-selected electronic devices being remote nodes including a controller and a memory, the memory having stored therein at least one remote virtual variable having a value representative of a state of said remote node, said remote virtual variable being reported by said controller of said remote node on said network in response to a change in said value of said remote virtual variable; and

at least one action being stored in said memory of said local node for execution by said controller of said local node, the action using said local virtual variable and said remote virtual variable;

wherein said controller of said local node is so configured as to execute said action stored in said memory of said local node in response to the reporting of said remote virtual variable, said action changing said value of said local virtual variable and modifying said state of said local node according to said value of said local virtual variable.

### BRIEF DESCRIPTION OF THE FIGURES

Embodiments of the invention will be described by way of example only with the help of the accompanying figures.

FIGS. 1a and 1b are the virtual variable general characteristics property parameters.

FIGS. 2a, 2b and 2c are the virtual variable reporting type property parameters.

FIGS. 3a to 3f are the virtual variable default value/value range property parameters.

FIG. 4 is a flowchart illustrating the method of creating a virtual variable.

FIGS. 5a and 5b show respectively simplified illustrations of the communication between two nodes having two different data variable types of a prior art system and the system in accordance with an embodiment of the present invention.

FIG. 6 shows the parameters of the remote virtual variable descriptor.

FIGS. 7a and 7b show the differences between compiled languages and interpreted languages.

FIG. 8 shows a simplified schematic of a system of two nodes, a switch and a lamp and their respective data variables.

FIGS. 9a and 9b show the virtual variable general characteristics property parameters of the virtual variables for the system of FIG. 8.

FIGS. 10a and 10b show the virtual variable reporting type property parameters of the virtual variables for the system of FIG. 8.

FIGS. 11a to 11e show the virtual variable default value/value range property parameters of the virtual variables for the system for FIG. 8.

FIG. 12 shows the parameters of the remote virtual variable descriptor for the system of FIG. 8.

FIGS. 13a and 13b show respectively the pseudocode and the actual code of an example program for the system of FIG. 8.

Table 1 is a listing of the virtual variable value types.

Table 2 is a listing of measurement units.

Table 3 is a listing of the token values.

### DETAILED DESCRIPTION

In standard programming structures, actions are performed on data variables. Before describing the structure of the program, the data variables will be defined. These data variables represent states and conditions of features relevant to the type of node. Examples of features include a temperature sensor of a thermostat, a state of a light switch or the volume of a television set. These data variables will from herein be defined as virtual variables.

Virtual Variable Properties

As mentioned earlier, virtual variables (V^{2) represent states or conditions of a node. They may be created by the manufacturer of the node or by the system installer. On a network, nodes have access to read the information provided by the V}² of every node and may use this information to control node parameters. The structure of the variables comprises several properties: general characteristics, V² reporting type, default value/value range and other properties. These will be described in more details.

Virtual Variable (V^{2) General Characteristics}

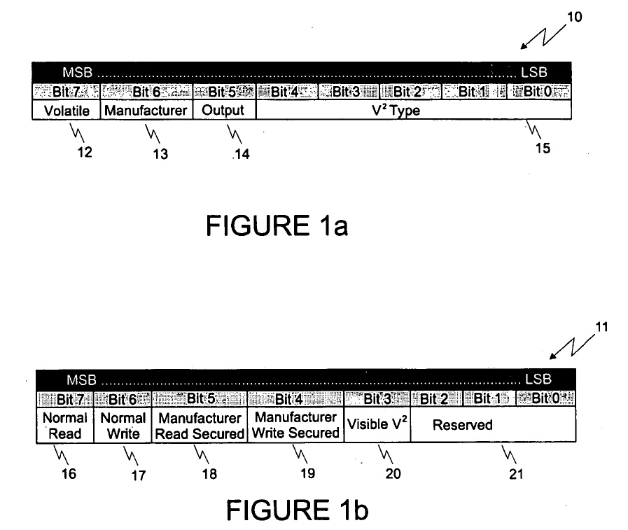

The general characteristics of a V² are stored within two bytes. FIG. 1a shows the most significant byte of the general characteristics (10) and FIG. 1b shows the least significant byte of the general characteristics (11). Byte (10) contains information relating to volatility (12), manufacturer (13), output (14) and V² type (15). Byte (11) includes the following fields: Normal Read (16), Normal Write (17), Manufacturer Read Secured (18), Manufacturer Write Secured (19), Visible V² bit (20) and Reserved bits (21).

Bit 7 of byte (10) describes the volatility (12) of the V² value. If set to one, the V² is initialized to a default value or to 0 depending on the configuration of the default value/value range property. If set to zero, the V² is initialized to the value stored in the node's flash memory. The exception is data V² that are always directly stored in flash memory. Bit 6 is the Manufacturer bit (13) and an indication of the source of the V². If set to one, the manufacturer has created the V². Otherwise, it indicates that it has been created in the field. Bit 5 is the Output bit (14) and describes where the V² is mapped. If it is set, the V² may be mapped to an output peripheral. Otherwise, the V² is mapped to an input peripheral. If mapped to an input peripheral, the V²'s value cannot be changed by the system software. Bits 0-4 describe the V² type (15). This property is discussed later.

Bits 4 to 7 of byte (11) deal with security and encryption. Bit 7 (16) of byte (11) is the Normal Read (16) property. If bit 7 (16) is set, the V² may be read without using any specific encryption key when the network is not encrypted, otherwise the Public Key is required. If bit (16) is not set, the V² cannot be read. Bit 6 is the Normal Write (17) property. If this bit is set, the V² may be written to without using any specific encryption key in the case the network is not encrypted, otherwise the Public Key is required. If this bit is not set, the V² cannot be written to. Bit 5 is the Manufacturer Read Secured bit (18). If this bit is set, the V² value may be read using the manufacturer key. This key is a manufacturer-defined encryption key and is used to protect secured properties and V² that are specific to the manufacturer. If neither the Manufacturer Read Secured bit (18) nor the Normal Read bit (16) is set, the V² value cannot be read from the communication medium. Bit 4 is the Manufacturer Write Secured bit (19). If this bit is set, the V² value may be written to using the manufacturer key. If neither the Manufacturer Write Secured bit (19) nor the Normal Write bit (17) is set, the V² value cannot be read from the communication medium. Bit 3 is the Visible V² (20) bit. When this bit is not set, an external application may hide the V² from the user's view. Otherwise, the V² may be shown. This is to avoid showing basic V² calculations used by the manufacturer in its manufacturer logic. This bit is for information purposes only, thus its value is not processed by the device's protocol. Bits 0 to 2 are Reserved bits (21) and are set to 0. They are available for use for future applications.

Earlier it was mentioned that bits 0 to 4 of byte (10) described the V² type (15). Table 1 lists possible V² types. These types include a boolean type (represents either true or false values), an unsigned character, a signed integer, a signed long integer, a floating-point number, a data variable and a string variable. The boolean and unsigned character are both one byte long; the signed integer is two bytes long; and the signed long integer and the floating number are both four bytes long. The length of the data and string V² value types varies from 0 to 246 bytes.

V² Reporting

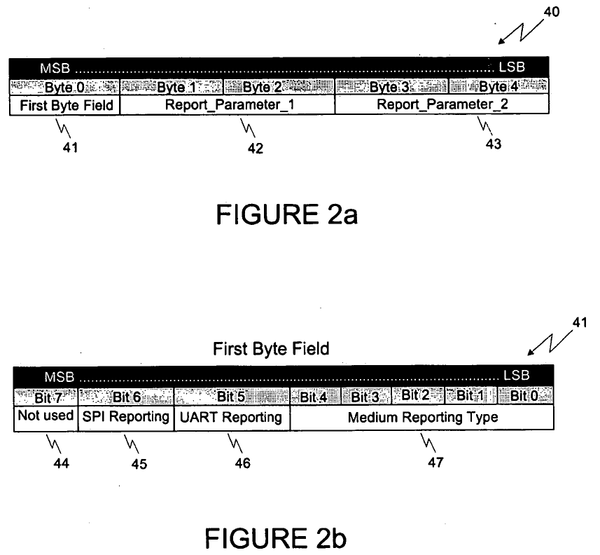

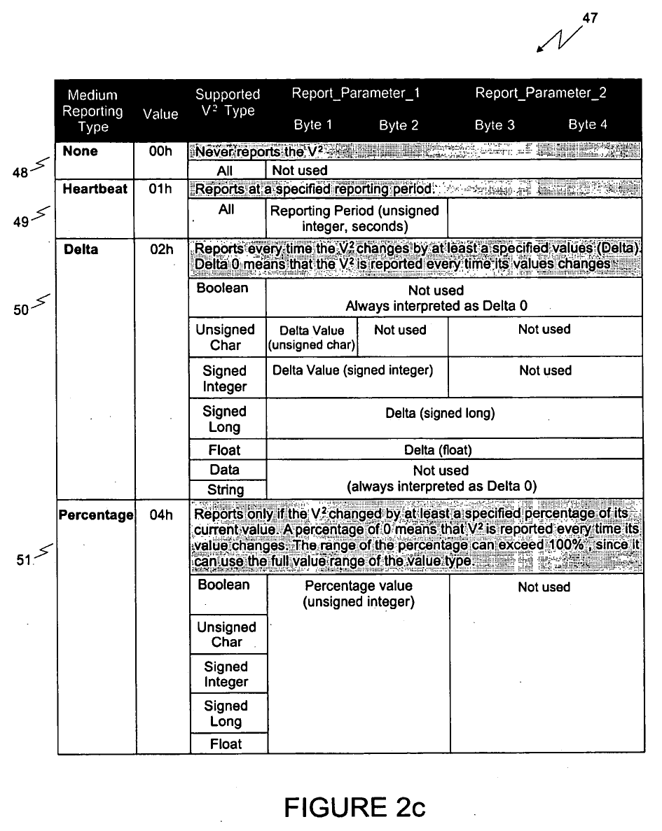

The V² reporting property is used to define how V²'s values are reported. FIG. 2a shows the five-byte property definition (40) and its contents including byte 0, the First Byte Field (41), bytes 1 and 2, Report_Parameter_1 (42) and bytes 3 and 4, Report_Parmeter_2 (43).

FIG. 2b shows the First Byte Field (41) definition including bit 7, which is an unused field (44), bit 6 that indicates Serial Peripheral Interface (SPI) Reporting (45), bit 5 that indicates Universal Asynchronous Receiver-Transmitter (UART) Reporting (46) and bits 0 to 4 that indicate the Medium Reporting Type (47). In this embodiment, two standard serial ports are used: an SPI and a UART.

If bit 6, the SPI Reporting (45) field is set, then the V² value is reported on the SPI port every time its value changes. If this bit is cleared, the V² value is never reported on the SPI port. If bit 5, the UART Reporting (46) field is set, then the V² value is reported on the UART interface every time its value changes. If this bit is cleared, the V² value is never reported on the UART interface. Bits 0 to 4 correspond to the Medium Reporting Type (47) field. This value determines how the V² value is reported to the medium so that other devices on the network receive its value when required. The Medium Reporting Type (47) field and the Report Parameter_1 (42) and the Report_Parameter_2 (43) fields (bytes 1 to 4 of the V² Reporting property) are set according to the table shown in FIG. 2c. There are four different Medium Reporting Types: None (51), Heartbeat (52), Delta (53) and Percentage (54). When the V² is never reported, None (51) is selected and the value in the Medium Reporting Type (47) field is 00 (hexadecimal notation). When Heartbeat (52) is selected, the device reports the V² value at a fixed rate or period. The value in the Medium Reporting Type (47) field is 01. When Delta (53) is selected, the device will report the V² value every time it changes by a specific value (delta). Delta 0 indicates that the V² value is reported every time its value changes. The value in the Medium Reporting Type (47) field is 0₂. When Percentage (54) is selected, the device will report the V² value only if it has changed by at least a specified percentage of its current value. A percentage of 0 means that the V² is reported every time its value changes.

V² Default Value/Value Range

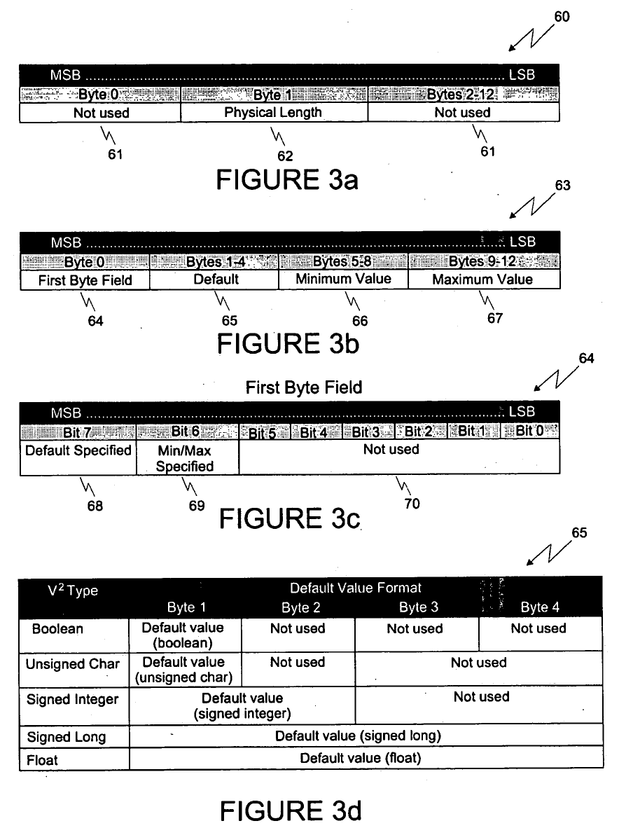

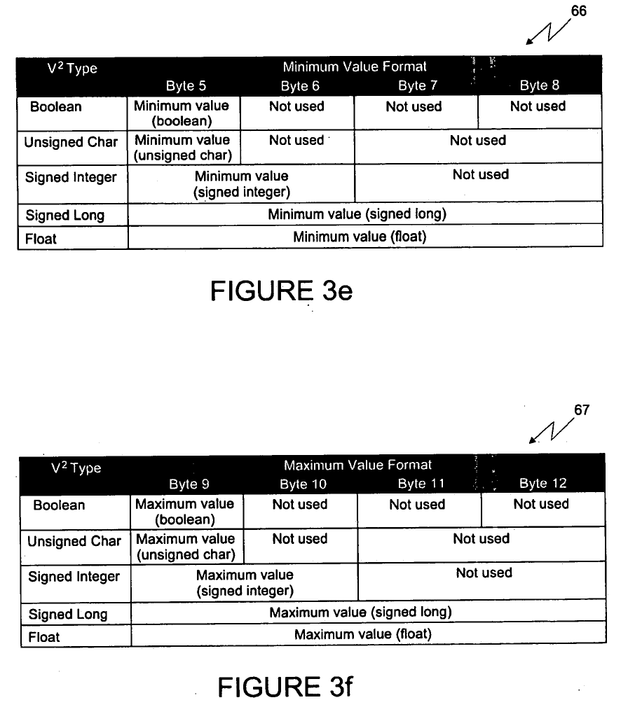

This property specifies a V²'s default value and its value range including minimum and maximum values. The default value is loaded at power-up for V² stored in volatile memory. FIGS. 3a and 3b show this twelve-byte property. FIG. 3a shows the V² default value/value range property (60) for the data V². Bytes 0, 2-12 are Not used fields (61). Byte 1 specifies the physical length of the data V². This physical length corresponds to the flash memory space reserved for the V²'s if its value type is data. This V² type does not have a default value. FIG. 3b shows the V² default value/value range property for all other V²'s (63). Byte 0 contains the First Byte Field (64), bytes 1 to 4 contain the Default value (65), bytes 5 to 8 contain the Minimum Value (66) and bytes 9 to 12 contain the Maximum Value (67).

FIG. 3c gives the breakdown of First Byte Field (64). Bit (68) is the Default Specified (68) field, bit 6 is the Min/Max Specified (69) field and bits 0-5 are not used. To specify a default value, the Default Specified (68) bit must be set, and the Default (65) field must be filled with a proper default value. The default value must be consistent with the V²'s value type. This same principle also applies for the Min/Max Specified (69) field. To specify a value range for the V²'s value, the Min/Max Specified (69) bit must be set and the Minimum Value and Maximum Value fields must be filled with the proper minimum and maximum values for the V². The minimum and maximum values must be consistent with the V²'s value type.

FIGS. 3d, 3e and 3f specify the Default Value (65), Minimum Value (66) and Maximum Value (67) fields for the various V² types including boolean, unsigned character, signed integer, signed long integer and floating-point number. The value formats for each type correspond to their lengths. Both boolean and unsigned character are one-byte long; the signed integer is two bytes long; and the signed long integer and floating-point number are four bytes long. These lengths are constant for the Default Value (65), Minimum Value (66) and the Maximum Value (67).

Other Properties

Along with the properties described earlier, the following properties are also associated with V²'s.

The V² Hardware Mapping property maps a V² to a hardware peripheral. Each element in this property is a one byte field that corresponds to a particular input or output peripheral.

The Units of Measure property specifies the V²'s measurement unit in relation to mass, area, temperature, electrical parameters, etc. These units are for information purposes only, thus its value is not processed by the device's protocol. Table 2 gives a detailed list of the various units.

The Name property stores personalized descriptors for the V²'s, i.e. fan speed, volume level, light switch status, etc. The Name property is used to describe each V², not to identify it.

Identification is done using a V² identification (ID) number. Each of the properties discussed so far is grouped in multi-element, two-dimensional arrays. The ID is given by the element index of the V² in the array, where the first ID has an ID of zero. For example, the V² whose configuration details are stored in the fifth element of the above properties has a V² ID of 4. This ID is used to refer to a particular V² in the programming logic scenarios.

Creating and Deleting V²'s

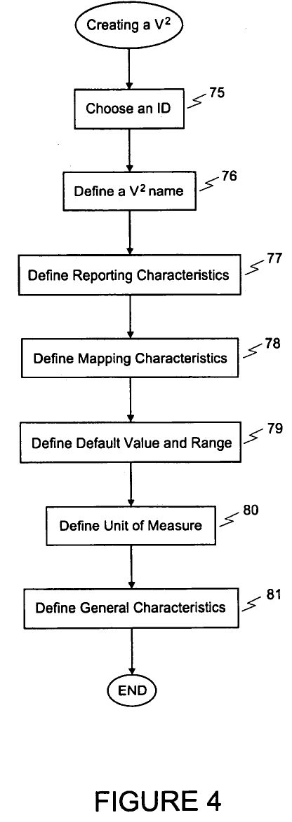

It is possible to create a V² on either a local device or a remote one. The process is outlined in FIG. 4 and involves the definition of the V² properties described earlier. The first step is to choose a V² ID (75). As described earlier, the first V² must have an ID of 0 and all subsequent V²'s must follow numerically (ID 1 for the second V², ID 2 for the third V², etc). This is important since, in the present embodiment, the chosen ID matches the corresponding element index of the two-dimensional array of V² properties. If an ID is skipped, by the device's controller ignores all V²'s having an ID greater than the skipped one. The second step involves defining a name (76) for the V². This name is only a descriptor for the V² and is not used in the programming logic. The third step involves defining the reporting characteristics (77). Details on the reporting characteristics were given in FIG. 2. The fourth step involves defining the mapping characteristics (78). As described earlier, each V² is mapped to a particular input or output peripheral. Each input and output peripheral has a property ID similar to a V². This ID is given in the one byte V² Hardware Mapping field. The fifth step involves defining the default value and range (minimum and maximum values) (79). Details of this were given in FIG. 3. The sixth step defines the unit of measure (80) relating to the particular V². The units are chosen among those defined in Table 2. The seventh and last step involves defining the V² General Characteristics property (81). These were outlined and described earlier in FIG. 1. They include, the V² type and security/encryption features. It is important to configure the V² General Characteristics property (81) after configuring the other six properties. If this does not happen, the V²'s behavior may be erroneous until all properties are correctly configured.

To delete a V², the corresponding element in the V² General Characteristics should be set to FFFFh. If a V² is deleted however, the node's controller ignores all V²'s having an ID greater than the deleted one. This is due to the way the controller scans the V²'s: it checks all elements in the V²'s General Characteristics starting from element 0, and increments until it finds an element having the FFFFh value.

Remote Virtual Variable Descriptor

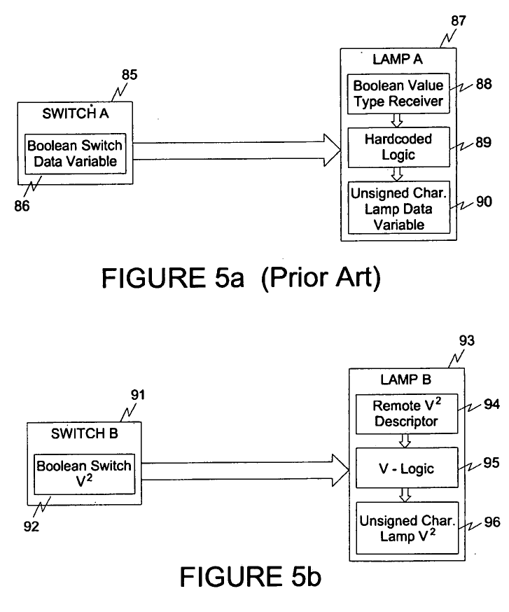

FIGS. 5a and 5b demonstrate an example system of two nodes, a switch and a lamp that each have one data variable. Each of these data variables use two different data variable value types. FIG. 5a shows a prior art system. This system consists of two nodes, switch A (85) and lamp A (87). Switch A's (85) data variable (86) is based on the boolean value type. It is in communication with lamp A (87) whose data variable is based on the unsigned character value type (90). To enable communication between the two nodes, the manufacturer of lamp A (87) must add the capability of receiving boolean value types. This data variable must be designed into the product. Therefore, the manufacturer must add a boolean value type receiver (88) to lamp A (87). The manufacturer must also add the necessary hardware logic complying to the system manufacturer's programming structure. For any product that has to communicate with different value types, corresponding value type receivers must be added by the product manufacturer. The product manufacturer must have advance knowledge of the devices and more specifically the remote data variables to which its product will be bound. It is difficult, therefore, for the end-user or system installer to make changes to the program specifications at a later time.

FIG. 5b shows a system similar to the system of FIG. 5a in accordance with an embodiment of the present invention. This system consists of two nodes, switch B (91) and lamp B (93). Switch B's (91) data variable (92) is based on a boolean value type. It is in communication with lamp B (93) whose V² is based on the unsigned character value type. A remote V² descriptor (94), that is part of the network programming language structure of the present invention, may accept a V² of any value type. It is possible to include more than one remote V² descriptor (94) to support a plurality of remote V².

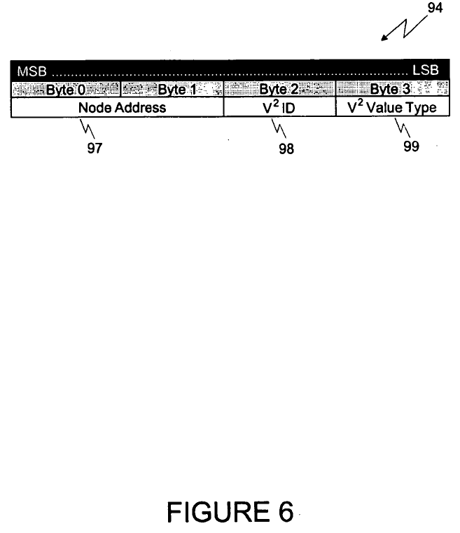

FIG. 6 shows the format of the Remote V² Descriptor (94). Bytes 0 and 1 contain the node address (97), byte 2 contains the V² ID (98) and byte 3 contains the V² value type (99). Value types were described in FIG. 2. The V-Logic may be set up by the system installer or the end-user, therefore it may be written in the field and the product manufacturer does not need to know details about the system that installs its product. Any V² may bind to other V²'s of a plurality of devices without these devices having prior knowledge of the remote devices and their V²'s.

Programming L gic Language

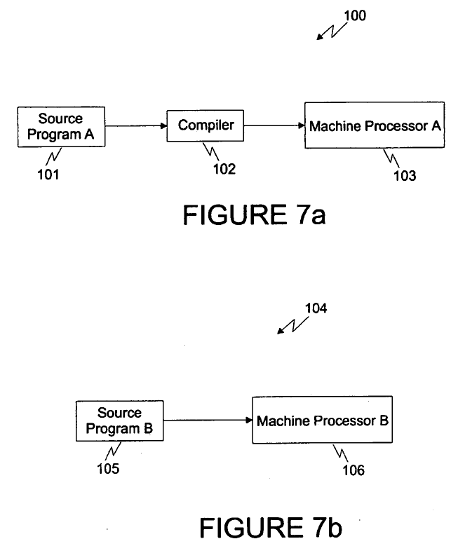

The properties of V²'s have been described in detail. These variables contain information related to the features of each node. To have a user or other nodes access and control this information, the network requires a communication process. Machine code will execute instructions based on user requirements. This code however requires explicit knowledge of the machine processes. A programming language that may be understood and executed by an end user is required. For machine understanding, the programming language needs to be converted to a form that is readable to their processors. The methods of program conversion and execution of a user's program may be classified into two basic techniques: 1) compilation and execution, or 2 interpretation. These two techniques are shown in simplified form in FIGS. 7a and 7b, respectively. FIG. 7a demonstrates the case of compilation and execution (100). Here the source program A (101) represents a programming language that requires compilation to translate it into machine code. This source program A (101) is converted to a compiled code using a compiler (102). The machine processor A (103), may then execute the instructions of the source program since the compiled code is machine readable. The compiler takes the source program (101) and translates it into executable files of binary machine code by the compiler (102). Once the binary code has been generated, it is stored in memory and the machine processor A (103) may execute it directly without looking at the source program (101) again. This method improves efficiency and saves time, but it is difficult to create code such as source program A (101). Knowledge of programming fundamentals is necessary since compiled languages may be difficult to program in. FIG. 7b shows the case of interpretation (104). Due to the programming structure of source program B (105), no compiling is needed. The source program B (105) is interpreted directly by the machine processor (106). The interpreter within machine processor B (106) translates and executes each statement of the source program B (105) before translating and executing the next one. As a result, no memory is required to store intermediate code, making it cost-effective. The execution time may be relatively slower, but with the current range of available high-speed controllers, delays are not an issue. Also, creating code for source program B (105) is usually simpler than using a compilation language.

The programming language used for reading and controlling the V²'s is an interpreted language. This language facilitates the creation of operational scenarios or logic between devices. All the devices in the network contain variable logic (V-Logic) as well as an interpreter to execute operations defined in the language.

Since all V-Logic scenarios are stored in flash memory, they may be reprogrammed in the field to enhance or update device functionality. The manufacturer may define it (mainly to define a device's local behavior), or the installer and end-user (to define the interaction between devices in a network). This gives more flexibility for the system installer or end-user to configure and program their devices according to their requirements as opposed to the manufacturers. To implement a V-Logic scenario, the Manufacturer Variable Logic or the Field Variable Logic property must be filled with a data string following the language format described below. It describes the syntax of the variable logic language following a BNF (Backus-Naur Form) format.

The format of a variable logic script contains a list of actions followed by an ‘END’ token to indicate the end of the script.

<V-Logic>::= <Action List><END Token>

The Action List is defined as a list of zero, one or several actions. There are different types of actions including IF and Conditional Statements, Timer, Computational, and Miscellaneous Actions. Each action corresponds to a particular token and each token has a hexadecimal value associated with it.

The following information provides the formats of the various actions attributed to the V-Logic language. Prior to describing these actions, it is necessary to introduce some common V-Logic elements.

Common Elements

<V²>

Some actions can use both local or remote V²'s while some other actions use only local V²'s.

<Local V²>

A local V² is a V² present in the local device. Its corresponding ID identifies it. The format is:

<Local V²> ::= <Local V² Token><Local V² ID>
<Local V² ID> ::= <00h...2Fh>
<Remote V²>

A remote V² is a V² present in a remote device. Its ID corresponds to the index of the element where the information about this V² is stored in the Remote V² descriptor property array.

<Remote V²> ::= <Remote V² Token><Remote V² cID>
<Remote V² ID>::= <00h...2Fh>
<Const>

Constant values are used in most V-Logic actions.

<Const> ::= <Const Token><Const Type><Data>
<Const Type> ::= <Boolean Token>| <Unsigned Char
Token>|<Signed Integer Token>|<Signed Long Token>|<Float
Token>|(<Data Token><Data Length>)
<Data Length> ::= <00h...F6h>
<Data> ::= Constant value according to the specified data type.
<Value>

A value is a V² value or a constant.

<Timer>

A V-Logic scenario can use up to 8 timers that are identified by <Timer> when using timer-related actions or flags.

<Timer> ::=<00h...07h>
<Timer Value>

Since a timer decrements from an initial value loaded by a Start Timer action, the timer value can be loaded in a V2 to retrieve the value of a timer, running or not, or be used to trigger actions or events.

The timer value can be used in several V-Logic actions:.

<Timer Value> ::= <Timer Value Token> <Timer ID>
<Timer Value Token> ::= <16h>
<Timer ID> ::= <00h...07h>
<IF> Statement, Conditions and Arguments
<IF> Statement

A variable logic IF statement contains the condition description and the actions and the actions to be executed if this conditions' value is greater than zero. An IF can contain an Action List, which can contain other IF's (as can be seen in the definition of the <Action List> element). This recursive concept gives the possibility to express interwoven IFs. It is also possible to associate ELSEIF and ELSE statements to an IF statement:

<IF>::= <IF Token><Condition><Action List>

(<ELSEIF Token><Condition><Action List>)
[<ELSE Token><Action List>]
<END Token>

Conditions

A condition is defined as a relational expression, a logical expression or an argument:

<Condition>::=[<NOT Token> ](<Logical Expression> |<Relational Expression>)

A logical expression contains a logical operator and multiple conditions:

<Logical Expression> ::= (<AND Token><Relational Expression> +

(<Relational Expression>)<END Token>)|
(<OR Token><Relational Expression> +
(<Relational Expression>)<END Token>)|
(<XOR Token><Relational Expression> +
(<Relational Expression>)<END Token>)

A relational expression contains a logical operator and multiple conditions. These include Greater Than Equal (GTE), Greater Than (GT), Less Than. Equal (LTE), Less Than (LT), Equal (EQ), Not Equal (NEQ). The format for this is as follows:

<Relational Expression> ::= (<GTE Token><Value><Value>)|

(<GT Token><Value><Value>)|
(<LTE Token><Value><Value>)|
(<LT Token><Value><Value>)|
(<EQ Token><Value><Value>)|
(<NEQ Token><Value><Value>)|
<Argument>

The <Value> token can be any V² type except for the data V².

Arguments

An <Argument> can be defined by a Timer's Status, a V²'s value status, a boolean V²'s value, a boolean constant or the TRUE and FALSE tokens:

<Argument> ::=
<OnTimerRunning>|<OnTimerExpired>|<OnValueChanged>|
<50msPassed>|<TRUE Token>|<FALSE Token>|<Value>

The <OnValueChanged> flag is set to TRUE when a V²'s value is written to (either by a variable-logic action, a message from a local host or from a remote device, or a change in a hardware peripheral state). The flag is reset to FALSE at the end of the Manufacturer variable-logic's execution. The format for this argument is:

<OnValueChanged> ::= <Value Changed Token><V²>

If the V²'s value is set by a variable logic action, the flag is set to TRUE even if the new value is equal to the previous one.

The <OnTimerRunning> flag is TRUE if the specified timer is currently running. It is set to FALSE when the timer expires and when it is stopped. The format for this argument is:

<OnTimerRunning> ::= <Timer Running Token><Timer>

The <OnTimerExpired> flag is set to TRUE when the specified timer expires. The format is:

<OnTimerExpired> ::= <Timer Expired Token><Timer>

The <50 msPassed flag is set every 50 ms. The flag is reset to FALSE at the end of the Manufacturer variable logic's execution. The format is:

<50msPassed> ::= <50ms Token>

Timer Actions

The variable logic language supports up to eight software timers, which can be used to control the duration of an action or the persistence of an input, to debounce a logic state, etc. The state of a timer can be read using the <OnTimerExpired> and <OnTimerRunning> flags. By default at startup, both flags are false for all timers.

<Start Timer>

The <Start Timer> action loads a timer with the <Timer Duration> value and starts the timer. After this action is called, the <OnTimerRunning> flag is set to TRUE and the <OnTimerExpired> flag is set to false. The format is:

<Start Timer> ::= <Start Timer Token><Timer><Timer Duration>
<Timer Duration> ::= <Value>

The <Timer> parameter represents the ID of the timer to be started. The <TimerDuration> is in increments of 50 ms and it supports the signed integer value type.

<Disable Timer>

The <Disable Timer> action stops the timer and the <OnTimerRunning> and <OnTimerExpired> flags are set to FALSE. The format is:

<Disable Timer> ::= <Disable Timer Token><Timer>

The <Timer> parameter represents the ID of the timer to be stopped.

Computational Actions

<Assign>

The <Assign> action copies the contents of a source V² or constant, into a destination V². If different V² types are used, the values are typecasted as in C code. The format is:

<Assign> ::= <Assign Token><V²><Value>

In C language, the action would be represented as follows: V²=Value;

The <V²> parameter represents V²'s to which a value is assigned. The <Value> parameter represents values assigned to the V²'s. All value types are supported by these two parameters.

<Add>

The <Add> action adds one or more values directly to a destination V². If different V² types are used, the values are typecasted as in C code. The format is:

<Add> ::= <Add Token><V²>(<Value>)+ <End Token>

In C language, the action would be represented as follows:

V² = V² + Value_1 + Value_2 + ...+ Value_N;

The <V²> parameter represents V²'s to which values are added. The <Value> parameter represents value(s) added to the V²'s. The value types are supported by these two parameters are the unsigned char, signed integer, signed long integer and floating point.

<Subtract>

The <Subtract> action subtracts one or more values directly from a target V². If different V² types are used, the values are typecasted as in C code. The format is:

<Subtract> ::= <Subtract Token><V²>(<Value>)+ <End Token>

In C language, the action would be represented as follows:

V² = V² − Value_1 − Value_2 − ...− Value_N;

The <V²> parameter represents V²'s from which values are subtracted. The <Value> parameter represents value(s) subtracted to the V²'s. The value types are supported by these two parameters are the unsigned char, signed integer, signed long integer and floating point.

<Multiply>

The <Multiply> action multiplies the content of a V² by one or several values. If different V² types are used, the values are typecasted as in C code. The format is:

<Multiply> ::= <Multiply Token><V²>(<Value>)+ <End Token>

In C language, the action would be represented as follows:

V² = V² * Value_1 * Value_2 * ...* Value_N;

The <V²> parameter represents V²'s multiplied by the values. The <Value> parameter represents value(s) used to multiply the V²'s value. The value types are supported by these two parameters are the unsigned character, signed integer, signed long integer and floating point.

<Divide>

The <Divide> action divides the content of a V² by one or several values. If different V² types are used, the values are typecasted as in C code. The format is:

<Divide> ::= <Divide Token><V²>(<Value>)+ <End Token>

In C language, the action would be represented as follows:

V² = V²/(Value_1 * Value_2 * ...* Value_N);

The V²> parameter represents V²'s divided by the values. The <Value> parameter represents values used to divide the V²'s value. The value types are supported by these two parameters are the unsigned char, signed integer, signed long integer and floating point.

Miscellaneous Actions

<Force Report>

The <Force Report> action forces the device to report a V²'s value on the medium. If the SPI Reporting bit is set in the V² Reporting property, the V² is also reported on the SPI interface. If the UART Reporting bit is set in the V² Reporting property, the V² is also reported on the UART interface. The format is:

<Force Report> ::= <Force Report Token><Local V²>

### EXAMPLES

The following example illustrates, in detail, the format of the V-Logic programming structure.

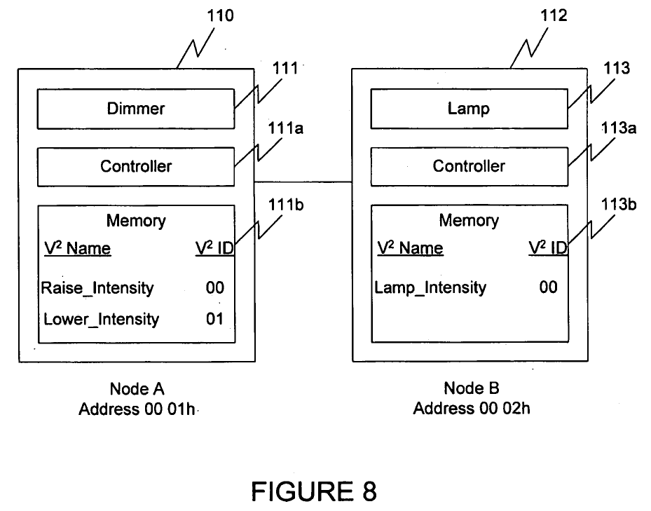

FIG. 8 shows an example of a network of two nodes: node A (110) and node B (112). Node A (110) has a network address of ‘00 01h’ and node B (112) has a network address of ‘00 02h’. Node A (110) contains a dimmer circuit (111) provided with a controller (111a) and a memory (111b). The state of node A (110) is represented by the V²'s of dimmer (111). The V²'s, named Raise Intensity and Lower Intensity, are defined as Remote V²'s who's values indicate if the intensity is to be raised or lowered, and have V² IDs of 00h and 01h, respectively. The values of the Raise Intensity and Lower Intensity V²'s may be set, for example, by corresponding buttons or switches. Node B (112) contains a lamp (113) provided with a controller (113a) and a memory (113b). The state of node B (112) is represented by the V² of lamp (113). The V², named Lamp Intensity, is defined as a Local V² who's value indicates the intensity level of lamp (113), and has V² ID of 00h. In one embodiment of this example, the controller (113a) is so configured that the lamp's (113) intensity increases from 0 to a maximum intensity of 100% at a rate of 1% every 50 milliseconds (ms), by raising the value of Local V² Lamp Intensity, when the Remote V² Raise Intensity is on. If the Remote V² Raise Intensity is off, the lamp's (113) intensity will stay at the last known state before the Remote V² Raise Intensity was turned off. Similarly, turning Remote V² Lower Intensity on or off will have the reverse effects.

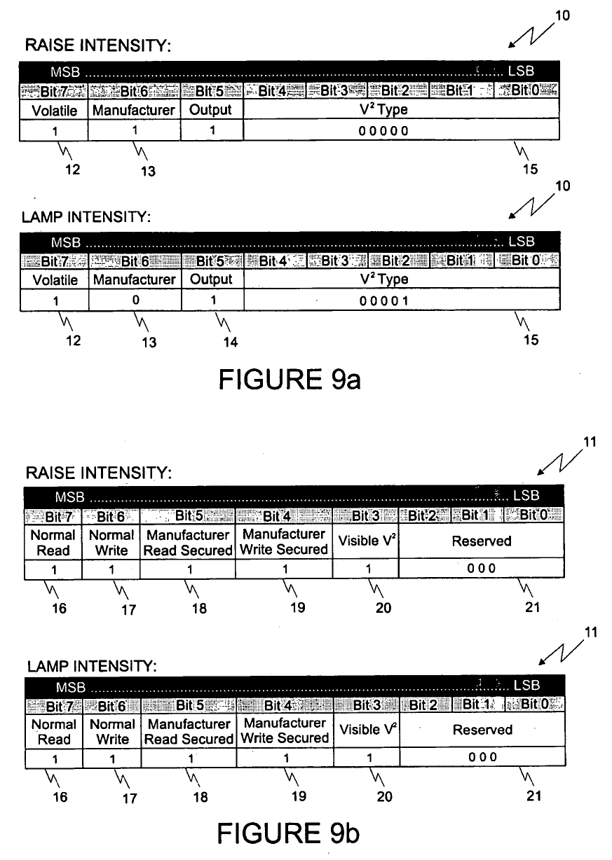

Before proceeding further, it may be useful to examine the properties of the V²'s of FIG. 8. For concision purposes, for dimmer (113) we will only examine the Raise Intensity V². FIG. 9a shows the most significant byte of the general characteristics (10) applied to this example. The format of this property follows that as shown in FIGS. 1a and 1b. The V² properties of each node are shown including the dimmer's (111) Raise Intensity V² and the lamp's (113) Lamp Intensity V². The Volatility (12) property is set to 1 for both dimmer's (111) Raise Intensity V² and the lamp's (113) Lamp Intensity V² meaning that the default values are stored in each of the V²'s respective default value property (60). The Manufacturer (13) property is set to 1 for the dimmer's (111) Raise Intensity V² as the manufacturer of the dimmer's (111) created the dimmer's (111) V²'s. The lamp's (113) Lamp Intensity V² however was created in the field and is a field V². The output property (14) for both the dimmer's (111) Raise Intensity V² and the lamp's (113) Lamp Intensity V² are set to one. This indicates that both of these V2's are mapped to output peripherals such as a bus or cable. This is necessary for communicating the value of the V²s. The value type of the dimmer's (111) Raise Intensity V² is boolean and is represented as such according to the value types table of Table 1. The value in the value type (15) property of byte (10) is given as ‘00000′. The value type of the lamp's (113) Lamp Intensity V² is unsigned character and its representation in the value type (15) property of byte (10) is ‘00001′.

FIG. 9b shows the least significant byte of the general characteristics (11). The first property of this byte (11) is the Normal Read (16) property. This property is set to one for both V²s. If it is not set, then the V² cannot be read. The Normal Write (17) property is also set for both V²s. If it is not set, then the V² cannot be written to. Both the Manufacturer Read Secured (18) property and the Manufacturer Write Secured property (19) must also. be set for all V²s, otherwise the V² cannot be read or written to. The Visible V² property (20) is set to one for both V²s. It is unnecessary to hide the V²s to the user. Reserved bits (21) are for future used and not used, therefore these bits are set to ‘000′ for both V²s.

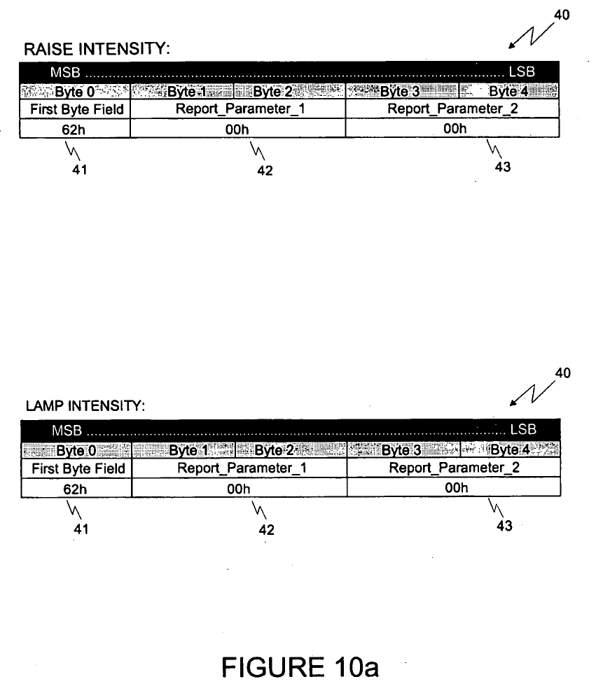

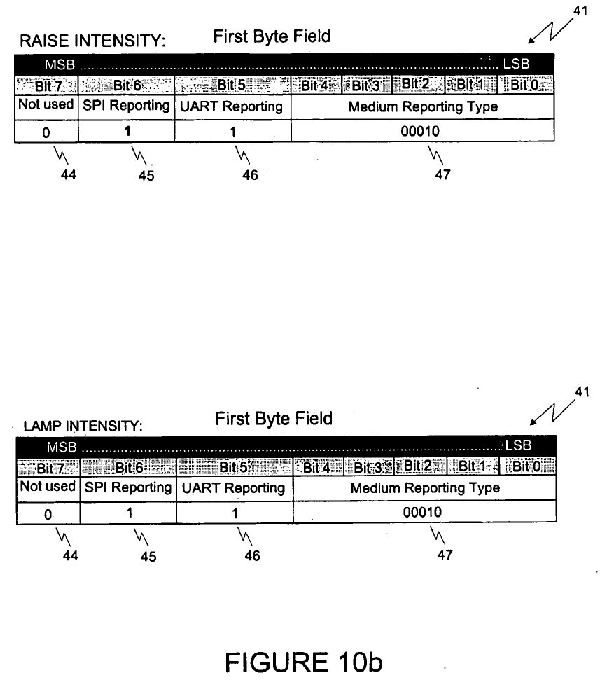

FIGS. 10a and 10b show the V² reporting property for both the dimmer's (111) and the lamp's (113) V²s. The format of this property follows that is shown in FIGS. 2a and 2b. FIG. 10a shows the five-byte property definition (40). The first byte field of the V² Reporting property (41) is ‘62h’ in hexadecimal notation for both of the V²s. FIG. 10b gives an explanation of this value. The Report_Parameter_1 field (42) and the Report._Parameter_2 field (43) are both set to zero. Further explanations are given below.

Bit 7 of the first byte field (44) is not used, and is therefore set to zero. Bit 6 is the SPI Reporting field (45) and bit 5 is the UART Reporting field (46). These fields are both set to one for both V²s since it was explained. in the output property (14) of the general characteristics that both of the V²s are coupled to output peripherals including the two standard serial ports. The Medium Reporting Type property (47) is set to ‘00010′ for both V²s. FIG. 3c gives a detailed explanation of the Medium Reporting Type property (47). The Medium Reporting Type for this example is Delta (50) for both of the V²s. In the case of the dimmer's (111) Raise Intensity V², because it is a boolean value type, it's Report_Parameter_1 (42) and Report_Parameter_2 (43) fields are always interpreted as Delta 0. This indicates that the dimmer's (111) Raise Intensity V² is reported every time its value changes. These fields are then set to zero. In the case of the lamp's (113) Lamp Intensity V², its value must also be reported every time it changes to ensure that is has not reached its maximum value. Once it does reach its maximum value, it is not necessary to increment it any further. Fields (42) and (43) are both set to zero.

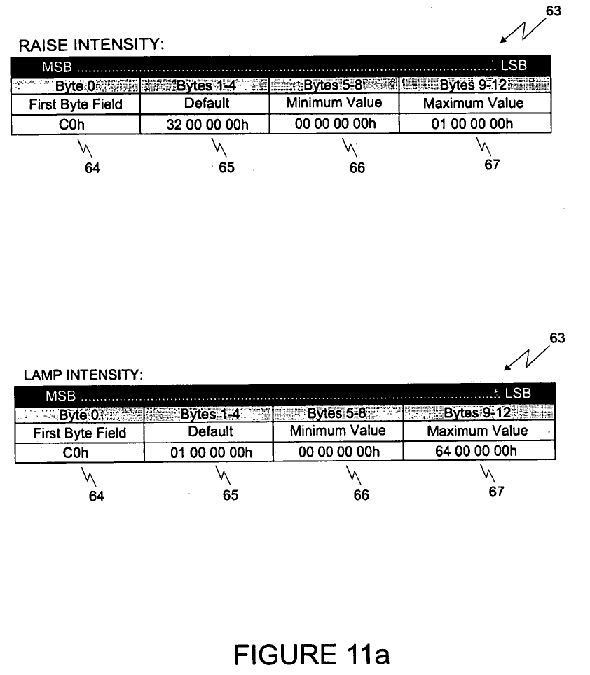

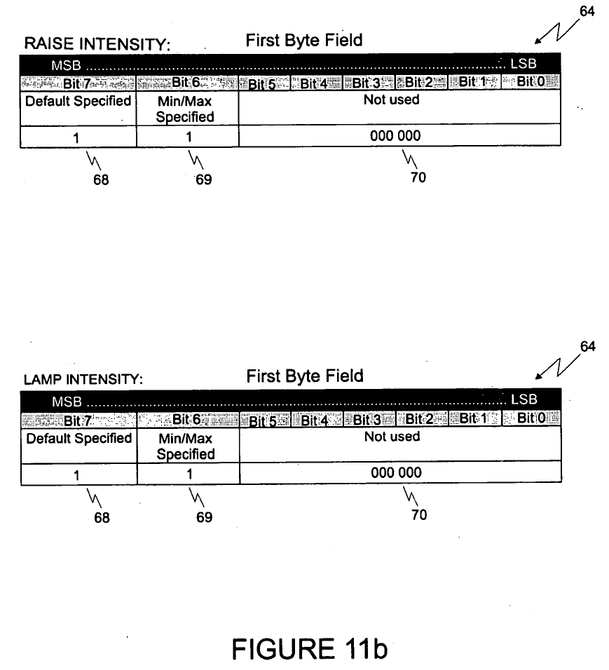

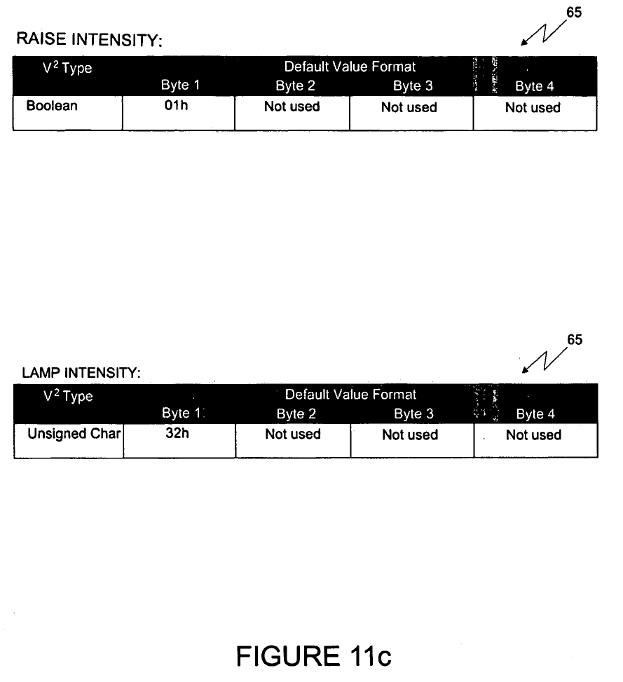

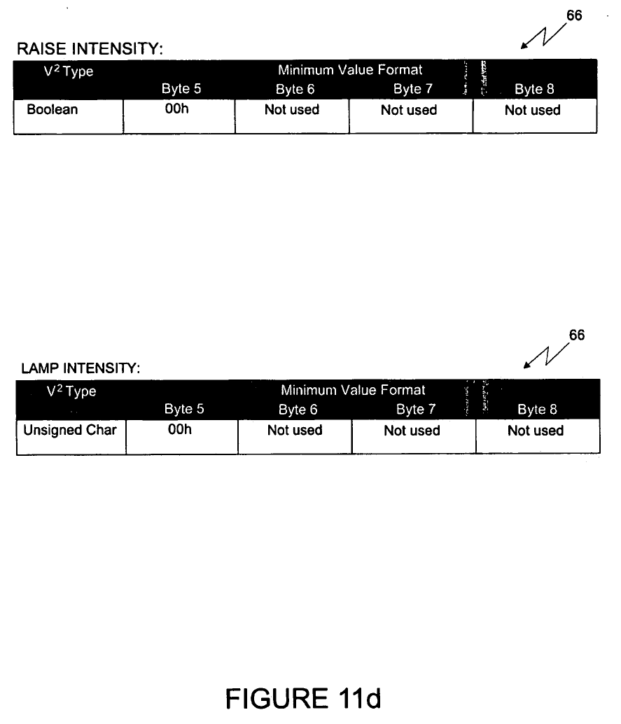

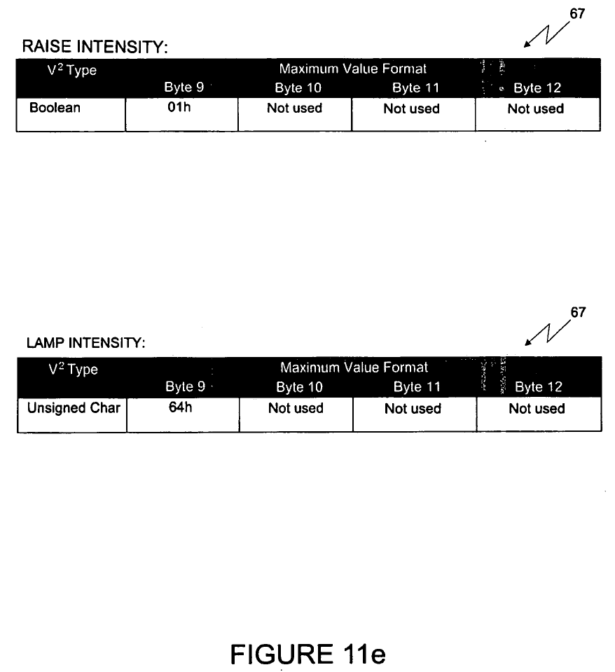

FIG. 11a is the V² default value/value range property (63). The format of this property follows that as shown in FIGS. 3b to 3f. The First Byte field of both V²s is set to ‘C0h’ for both V²s. The Default field (65) for the dimmer's (111) Raise Intensity V² is given as ‘01 00 00 00h’. The Default field (65) for the lamp's (113) Lamp Intensity V² is given as ‘32 00 00 00h’. The Details on the values of the First Byte field of the V² default value/value range property (64), Default field (65), Minimum Value field (66) and Maximum Value field (67) are given in FIGS. 11b, 11c, 11d and 11e respectively.

The Default Specified field (68) and the Min/Max Specified field (69) must both be set to one to indicate that default, minimum and maximum fields are given. The remaining bits in this field are not used and therefore set to zero. The resulting byte is ‘11000000’ or ‘C0’ in hexadecimal notation. Both V²s have the same First Byte field (64).

The Default field (65). specifies the exact default value. The dimmer's (111) Raise Intensity V² has two states: on or off. If the default is the ‘on’ state, the default value is ‘01h’. The lamp's (113) Lamp Intensity V² has fully on, fully off and different levels of intensity states in between. If the default is 50% intensity, then the default is ‘32h’. Bytes 2, 3 and 4 of the Default Value Format are not used and therefore set to zero.

The Minimum Value field (66) specifies the minimum value in the range of values of the particular V². The minimum value of the dimmer's (111) Raise Intensity V² is off or ‘00h’. The minimum value of the lamp's (113) Lamp Intensity V² is off or ‘00h’. Bytes 2, 3 and 4 of the Default Value Format are not used and therefore set to zero.

The Maximum Value field (67) specifies the maximum value in the range of values of the particular V². The maximum value of the dimmer's (111) Raise Intensity V² is on or ‘01h’. The maximum value of the lamp's (113) Lamp Intensity V² is on or ‘64h’. Bytes 2, 3 and 4 of the Default Value Format are not used and therefore set to zero.

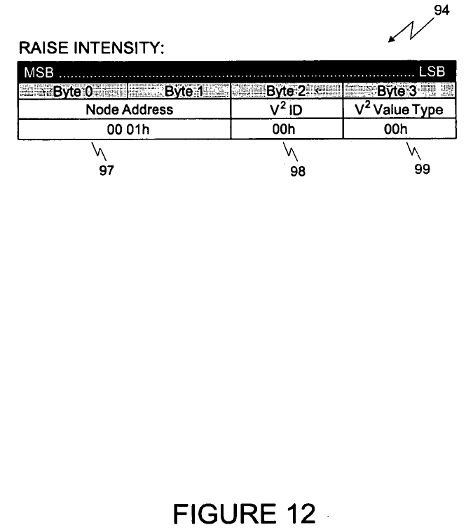

FIG. 12 shows the Remote V² Descriptor (94) of the dimmer's (111) Raise Intensity V² since it is a remote V². This Remote V² Descriptor (94) is contained within node B (112). The format of this property was described in FIG. 6. The dimmer's (111) Raise Intensity V² is a V² belonging to node A (110) and its two-byte node address (97) is given as ‘00 01h’ from FIG. 8. The V² ID (98) is ‘00h’ and the V² Value Type (99) is boolean. In hexadecimal notation, 00h represents the boolean value type.

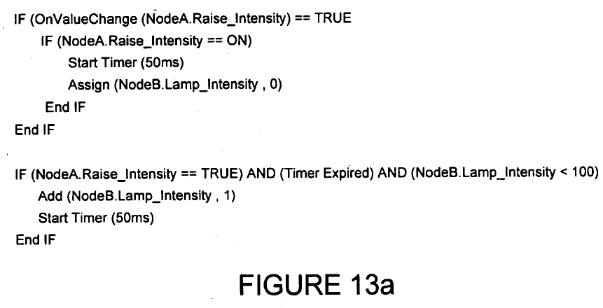

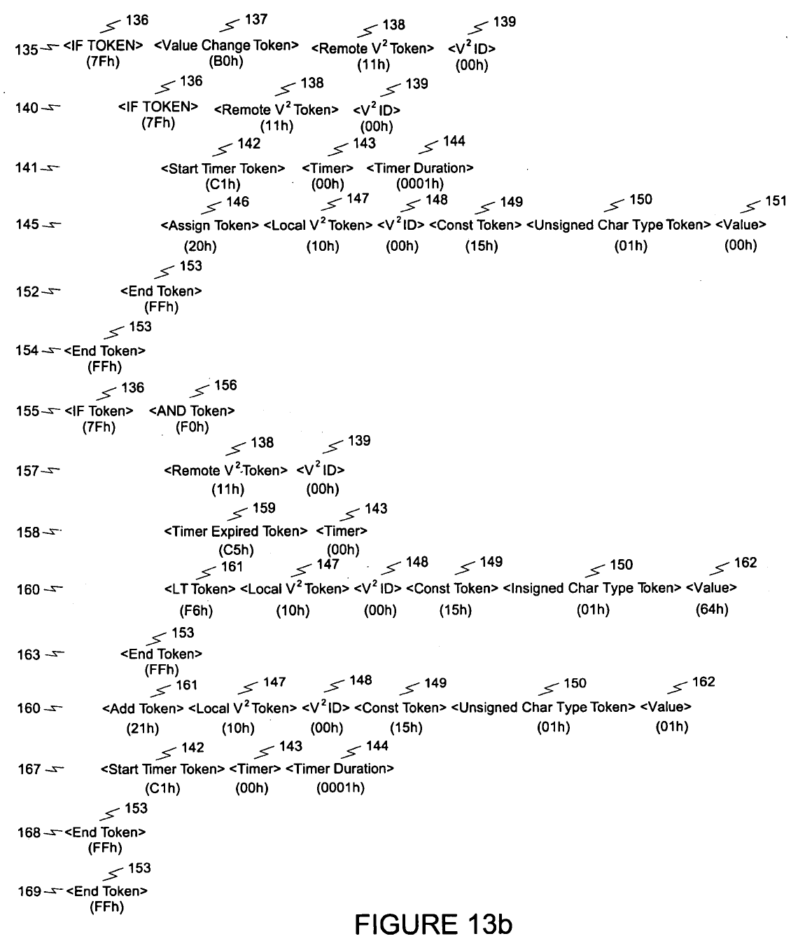

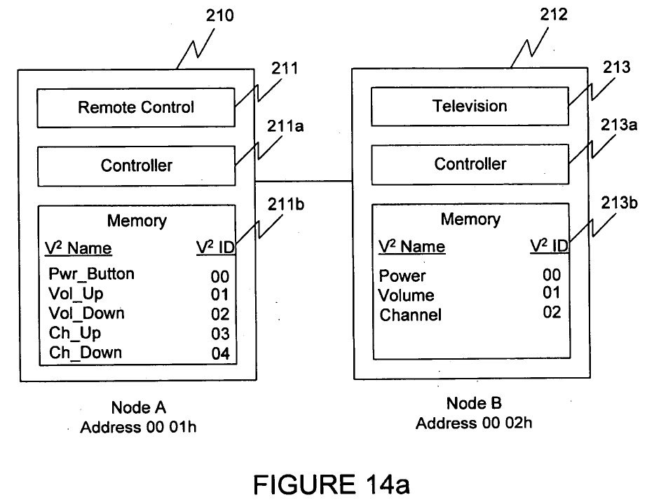

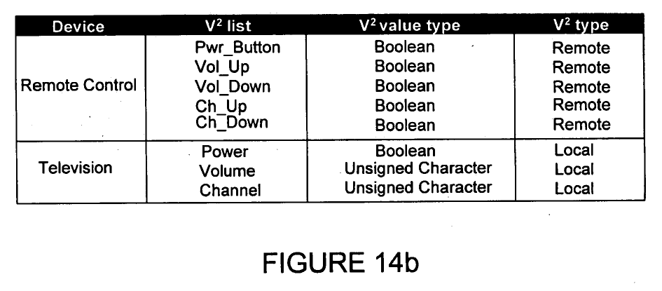

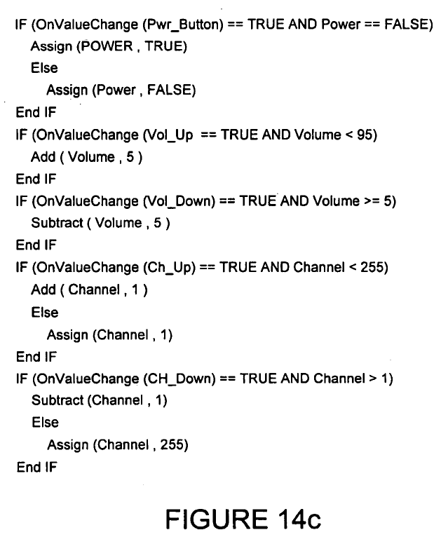

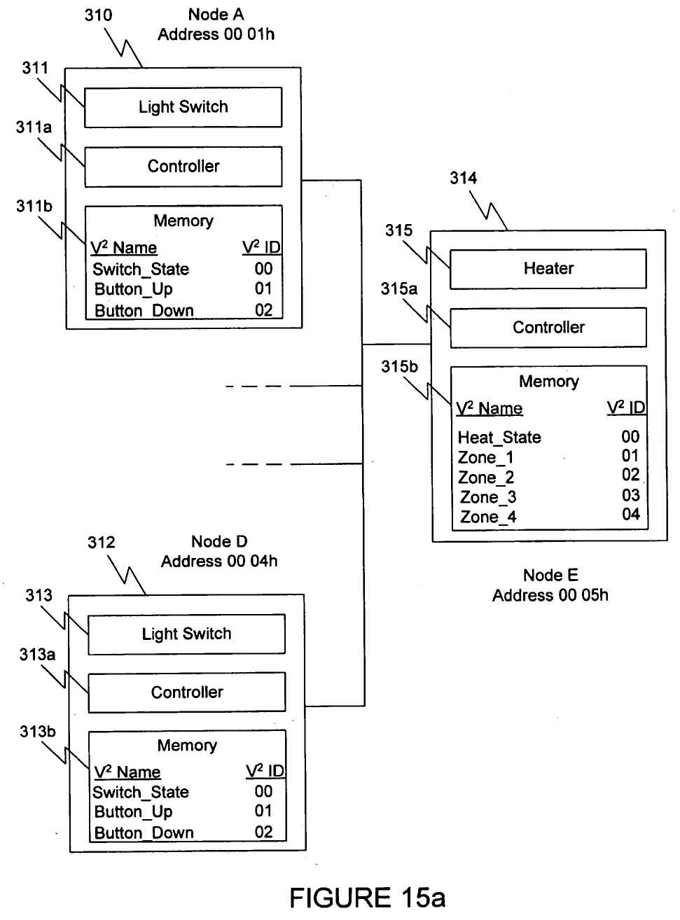

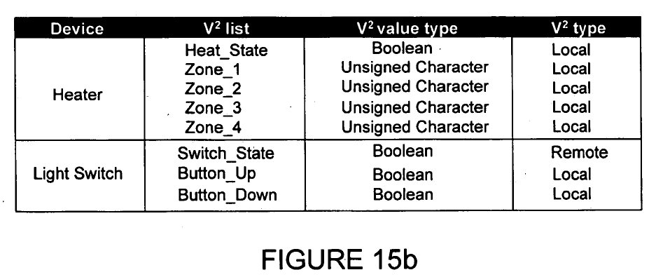

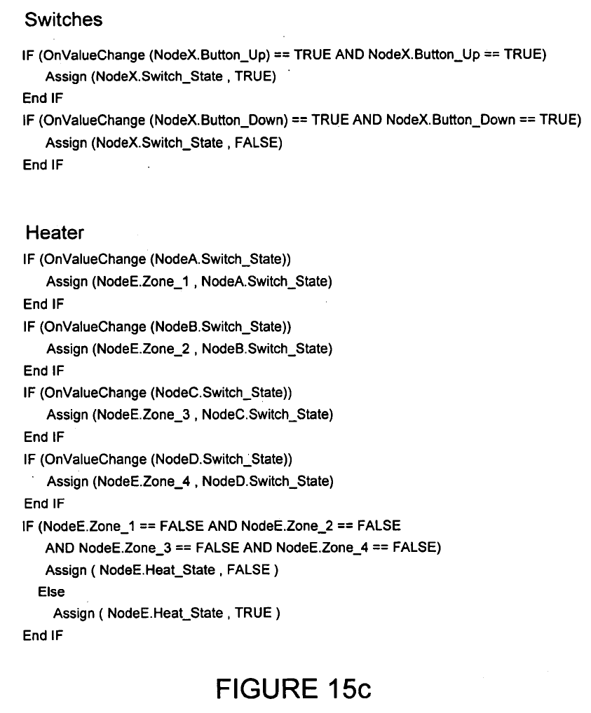

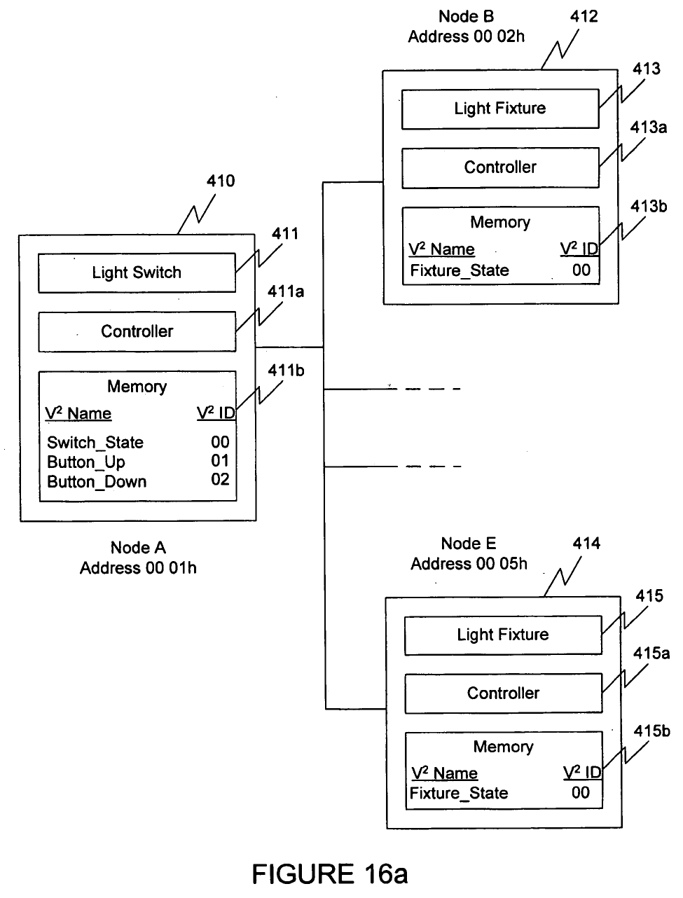

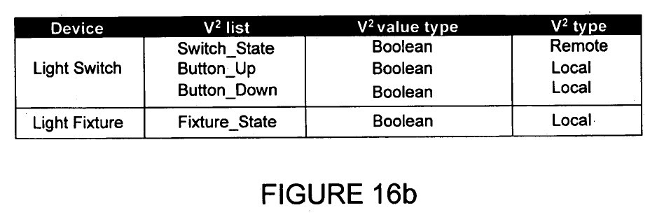

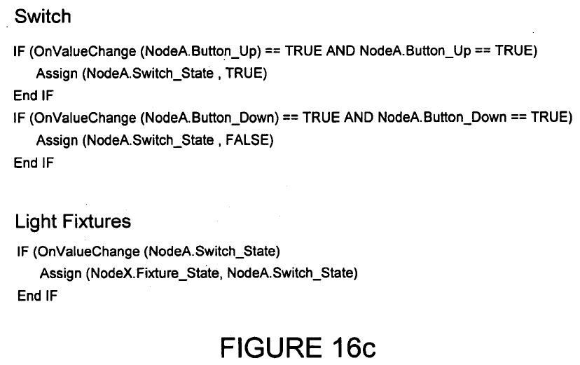

FIG. 13a gives the associative program in pseudocode for the raising of the lamp's (113) intensity, again for simplicity, the program for the lowering of the lamp's (113) intensity being similar. Lines (115) to (120) detect the transition of dimmer's (111) Raise Intensity V² and initiate the timer. Lines (121) to (124) deal with incrementing the lamp's (113) intensity. The first line of this code (115) determines if there is a change in the dimmer's (111) Raise Intensity V² status, i.e. the dimmer's (111) Raise Intensity V² is turned from on to off or off to on. The second line (116) is a nested IF statement and assuming there is a change in the dimmer's (111) Raise Intensity V² status, it determines if the transition of dimmer's (111) Raise Intensity V² is from off to on. The third line (117) initiates the ramp timer to 50 ms assuming that there was a dimmer's (111) Raise Intensity V² transition and it was from off to on. The fourth line (118) initializes the lamp (113) intensity to 0%. Line (119) closes the IF block started by line (116). Line (120) closes the IF block started by line (115). Line (121) determines if the dimmer's (111) Raise Intensity V² is still on, if the timer has expired and if the lamp's (113) Lamp Intensity V² is still less than the maximum intensity. If all these conditions are true, then line (122) goes on to increment the lamp's (113) Lamp Intensity V² by 1%. Line (123) restarts the ramp timer to count for 50 ms. Line (124) ends the IF block started by line (121).

FIG. 13b gives the actual V-logic program listing for node B (112). Node B (112) is the local node and node A (110) is the remote node. The lamp's (113) Lamp Intensity V² represents the local V² and the dimmer's (111) Raise Intensity V² is a remote V². Line (135) is the V-Logic code representing line (115). Line (135) begins with the <IF Token> (136), followed by the action statement <Value Changed Token> (137) and the V² information. The <Remote V² Token> (138) identifies the switch state as a remote V² and the <V² ID> (139) identifies the particular V² of the remote node. Line (140) represents line (116). By writing the code using only an <IF Token> (136) and a V² token, it is implied that the V² is in its default state (in this case true or on). This is only true in the case of boolean value types. Line (141) represents line (117).

The <Start Timer Token> (142) initiates the timer action. The <Timer> (143) token specifies the identification of the particular timer. The <Timer Duration> (144) token, as the name implies, specifies the duration of the timer. As stated in Table 2, the <Timer Duration> token is in increments of 50 ms. Line (145) represents line (118). This line initializes the lamp's (113) Lamp Intensity V² to a value of zero. The <Assign Token> (146) is an action statement that assigns a value to a V². The value is being assigned to the lamp's (113) Lamp Intensity V² that is a local V², thus the <Local V²> token is used (147) as well as its corresponding V² ID (148). The type of value is a constant and the format of this is described further in Table 2. It includes the <Const Token> (149), the constant type and the value. The <Unsigned Char Type Token> (150) identifies the type of constant as an unsigned character and <Value> (151) gives the value of the constant. Line (152) ends the IF block started by line (135) by using an <End Token> (153) and line (154) ends the IF block started by line (140) by also using <End Token> (153). Lines (155), (156), (157), (159) and (162) represent line (121). Line (155) consists of <IF Token> (136) and the <AND Token> (156). According to the structure of the programming language, the relational expressions that follow a logical expression are all bound by the logical expression. An <END Token> (153) signifies the end of the group of relational expressions. In this case, there are three relational expressions that must be satisfied in order to proceed: the dimmer's (111) Raise Intensity V² should be on, the timer (143) should be expired and the lamp's (113) Lamp Intensity V² should be less than 100%. Line (157) examines the state of the dimmer's (111) Raise Intensity V² as seen by the lamp (113), thus justifying the use of the <Remote V² Token> (138).

As described earlier, Line (158) checks for timer expiration by using the <Timer Expired Token> (159) along with the ID of the appropriate timer with the <Timer> (143) token. Line (160) is a relational expression that examines if the local V², the lamp's (113) Lamp Intensity V² is less than a given value, in this case, one hundred. This line (160) begins with the Less Than logical operator, <LT Token> (161), followed by the subject of the operation. The lamp (113) is the local node, so the <Local V² Token> (147) and its corresponding ID (148) are used. The value in question is a constant value. As explained for line (145), the format for a constant expression includes the <Const Token> (149), the constant type and the value. Again the <Unsigned Char Type Token> is selected and the <Value> (162) represents one hundred in hexadecimal notation. Line (163) ends the block of relational expressions started by the <AND Token> (156) of line (155) with an <END Token> (153).

Assuming that all of the conditions of the <AND> block are met, the lamp's (113) intensity increments by one. Line (164) is similar in construct to line (160). The computational action statement for addition is represented by the <Add Token> (165). This statement is followed by the relational expression that is the subject of the addition and the amount to be added. The lamp's (113) Lamp Intensity V² is a local V², so the <Local V² Token> (147) and its corresponding ID (148) represents this. The number one is represented in the same way as the number one hundred through the use of the <Const Token> (149), the <Unsigned Char Type Token> (150) and the <Value> (166) represents one in hexadecimal notation. After the incrementing of the lamp's (113) Lamp Intensity V², the timer must be started up again for another 50 ms. Line (167) is the same as line (141). The <Start Timer Token> (142) initiates the timer. The ID of the particular timer is given by the <Timer> (143) token and the duration of the timer, in increments of 50 ms, is given with the <Timer Duration> (144) token. Line (168) ends the IF block started by line (155) with an <END Token> (153) and line (169) ends the entire block of V-Logic code for this example with another <END Token> (153).

Further examples of configurations and control scenarios, which may be addressed using the V-Logic programming structure, are illustrated by FIGS. 14a, 15a and 16a.

FIG. 14a shows an example of a network of two nodes: node A (210) and node B (212). Node A (210) has a network address of ‘00 01h’ and node B (212) has a network address of ‘00 02h’. Node A (210) contains a remote control (211) provided with a controller (211a) and a memory (211b) for controlling Node B (212), which contains a television (213) provided with a controller (213a) and a memory (213b). The state of node A (210) is represented by the V²'s of the remote control (111). The V²'s, named Pwr_Button, Vol_Up, Vol_Down, Ch_Up and Ch_Down are defined, as shown in FIG. 14b, as Remote V²'s who's values indicate power on/off (TRUE/FALSE), raising of the volume, lowering of the volume, selecting the next channel and selecting the previous channel, respectively, and have V² IDs of 00h to 04h, respectively. The values of the remote control (211) V²'s may be set, for example, by corresponding buttons or pressure sensors. The state of node B (212) is represented by the V²'s of television (213). The V²'s, named Power, Volume and Channel, are defined, as shown in FIG. 14b, as Local V²'s who's values indicates power on/off, volume level and channel, respectively, of television (213), and have V² ID of 00h to O₂h, respectively. In one embodiment of this example, the controller (213a) is configured as illustrated by the pseudocode shown in FIG. 14c.

When the television's (213) Local V² Power value is FALSE and the remote control's (211) Remote V² Pwr_Button value is TRUE (Pwr_Button is activated), then the Local V² Power value is set to TRUE, changing the state of television (213) so that it is turned on. Conversely, when the television's (213) Local V² Power value is TRUE and the Remote V² Pwr_Button value is TRUE (Pwr_Button is activated), then the Local V² Power value is set to FALSE, changing the state of television (213) so that it is turned off.

Each time the remote control's (211) Remote V² Vol_Up value is TRUE (Vol_Up is activated), the television's (213) volume level increases by 5, up to a maximum level of 95, by raising the value of Local V² Volume. Conversely, each time the remote control's (211) Remote V² Vol_Down value is TRUE (Vol_Down is activated), the television's (213) volume level decreases by 5, down to a minimum level of 0, by lowering the value of Local V² Volume.

Similarly, each time the remote control's (211) Remote V² Ch_Up value is TRUE (Ch_Up is activated), the television's (213) channel increases by 1, up to a maximum channel of 255 after which the channel is set to 1, by raising the value of Local V² Channel. Conversely, each time the remote control's (211) Remote V² Ch_Down value is TRUE (Ch_Down is activated), the television's (213) channel decreases by 1, down to a minimum channel of 1 after which the channel is set to 255, by lowering the value of Local V² Channel.

FIG. 15a shows an example of a network with five nodes, of which node A (310), node D (312) and node E (314) are represented for concision purposes as node B and node C are similar to node A and node D. Node A (310) has a network address of ‘00 01h’, node D (312) has a network address of ‘00 04h’ and node E (314) has a network address of ‘00 05h’. Node A (310) and node D (312) contain light switches (311) and (313), provided with controllers (311a) and (313a) and memories (31 lb) and (313b), respectively, as do node B and node C (not represented), and are monitored by node E (314), which contains a heater (315) provided with controller (315a) and memory (315b). The state of node A (310) is represented by the V²'s of light switch (311). The V²'s, named Switch_State, Button_Up and Button_Down are defined, as shown in FIG. 15b, as a Remote and two Local V²'s, respectively, who's values indicate power on/off, activating the switch and deactivating the switch, respectively, and have V² IDs of 00h to O₂h, respectively. The same structure applies to node B, node C and node D (312). The values of the light switch's (311) Local V²'s may be set, for example, by corresponding buttons or pressure sensors. In one embodiment of this example, the controller (313a) is configured as illustrated by the pseudocode shown in FIG. 15c.

When the light switch's (311) Local V² Button_Up value is TRUE (Button_Up is activated), then the light switch's (311) Remote V² Switch_State value is set to TRUE, indicating to a remote node that the light switch (311) has been activated. Conversely, when the light switch's (311) Local V² Button_Down value is TRUE (Button_Down is activated), then the light switch's (311) Remote V² Switch_State value is set to False, indicating to a remote node that the light switch (311) has been deactivated.

The state of node E (314) is represented by the V²'s of heater (315). The V²'s, named Heater_State, Zone_1, Zone_2, Zone_3 and Zone_4, are defined, as shown in FIG. 15b, as a Local V² who's values indicate if the heater (315) is on/off, and the states of the monitored light switches contained in nodes A, B, C and D, respectively, and have V² ID of 00h to 04h, respectively. In one embodiment of this example, the controller (315a) is configured as illustrated by the pseudocode shown in FIG. 15c.

The heater (315) sets the values of its Local V²'s Zone_1, Zone_2, Zone_3 and Zone_4 to the state of each of the corresponding monitored light switches contained in nodes A, B, C and D, respectively. When the value of the Local V²'s Zone_1, Zone_2, Zone_3 and Zone_4 are all FALSE, meaning all the light switches have been turned off, the heater's (315) Local V² Heater_State value is set to FALSE, shutting off heater (315). This simplified scenario may be used to conserve energy by supposing that having all of the light switches turned off indicates that all the inhabitants of a household have gone to bed, of course other variables may be monitored by heater (315) and may be used in the determination of when to effectively shut it off.

FIG. 16a shows an example of a network of five nodes, of which node A (410), node B (412) and node E (414) are represented for concision purposes as node C and node D are similar to node B and node E. Node A (410) has a network address of ‘00 01h’, node B (412) has a network address of ‘00 02h’ and node E (414) has a network address of ‘00 05h’. Node A (410) contains a light switch (411) provided with controller (411a) and memory (411b), for controlling node B (412) and node D (414), which contain light fixtures (413) and (415), provided with controllers (413a) and (415a) and memories (413b) and (415b), respectively, as well as node C and node D (not represented). The state of node A (410) is represented by the V²'s of light switch (411). The V²'s, named Switch_State, Button_Up and Button_Down are defined, as shown in FIG. 16b, as a Remote and two Local V²'s, respectively, who's values indicate power on/off, activating the switch and deactivating the switch, respectively, and have V² IDs of 00h to 0₂h, respectively. The values of the light switch's (411) Local V²'s may be set, for example, by corresponding buttons or pressure sensors. In one embodiment of this example, the controller (411a) is configured as illustrated by the pseudocode shown in FIG. 16c.

When the light switch's (411) Local V² Button_Up value is TRUE (Button_Up is activated), then the light switch's (411) Remote V² Switch_State value is set to TRUE, indicating to remote nodes that the light switch (411) has been activated. Conversely, when the light switch's (411) Local V² Button_Down value is TRUE (Button_Down is activated), then the light switch's (411) Remote V² Switch_State value is set to False, indicating to remote nodes that the light switch (411) has been deactivated.

The state of node B (412) is represented by the V² of light fixture (413). The V², named Fixture_State is defined, as shown in FIG. 16b, as a Local V² who's value indicates if the light fixture (413) is on or off, and has V² ID of 00h. The same structure applies to node C, node D and node E (414). In one embodiment of this example, the controller (413a) is configured as illustrated by the pseudocode shown in FIG. 16c.

Each of the light fixtures (413) and (415), as well as those of node B and node D, set the value of their respective Local V² Fixture_State to the value of the light switch's (411) Remote V² Switch_State. Thus, by activating or deactivating a single light switch (411), four different light fixtures (413), (415) and those of node B and node D, are turned on or off simultaneously. Of course, the number of light switches and light fixtures may be different that that illustrated by the previous example.

Although the present invention has been described by way of particular embodiments and examples thereof, it should be noted that it will be apparent to persons skilled in the art that modifications may be applied to the present particular embodiment without departing from the scope of the present invention.

| Value Type | Value Type | | |
|---|---|---|---|
| Name | (hexadecimal) | Length (Bytes) | Range |
| Boolean | 00h | 1 | 00h . . . 01h |
| Unsigned | 01h | 1 | 00h . . . FFh |
| Char | | | |
| Signed | 02h | 2 | 0000h . . . FFFFh (where MSB is the |
| Integer | | | sign bit) |
| Signed | 03h | 4 | 00000000h . . . FFFFFFFFh (where |
| Long | | | MSB is the sign bit) |
| Float | 04h | 4 | 00000000h . . . FFFFFFFFh following |
| | | | IEEE Big Endian format |
| Data | 05h | 0 . . . 246. The length is on | Any hexadecimal string |
| | | one byte (unsigned char). | |
| String | 06h | 0 . . . 246. The length is on | Any ASCII string |
| | | one byte (unsigned char). | |

TABLE 2

| | V² Units of Measure | | | |
|---|---|---|---|---|
| Measurement | Property Value | | | |
| Type | MSB | LSB | Unit of Measure | Symbol |

No Specified Unit

| | | | | |
|---|---|---|---|---|
| No Unit | 00h | 00h | N/A | N/A |

Length

| | | | | |
|---|---|---|---|---|
| Length | 10h | 08h | kilometer | km |
| | | 0Bh | meter | m |
| | | 0Dh | centimeter | cm |
| | | 0Eh | millimeter | mm |
| | | 0Fh | micrometer | μm |
| | | 10h | nanometer | nm |
| | | 16h | mile | mi |
| | | 19h | yard | yd |
| | | 1Ah | toot | ft |
| | | 1Bh | inch | in |
| | | 1Dh | mil (thou) | — |
| | | 21h | angstrom | A |
| | | 22h | nautical mile | nmi |
| | | 30h | picas (computer) | pi |
| | | 31h | picas (printer) | pi |
| | | 32h | point (computer) | pt |
| | | 33h | point (printer) | pt |

Area

| | | | | |
|---|---|---|---|---|
| Area | 12h | 08h | square kilometer | km² |
| | | 09h | hectare | ha (hm²) |
| | | | (square hectometer) | |
| | | 0Bh | square meter | m² |
| | | 0Eh | square millimeter | mm² |
| | | 0Fh | square micrometer | μm² |
| | | 10h | square nanometer | nm² |
| | | 16h | square mile | mi² |
| | | 17h | acre | N/A |
| | | 19h | square yard | yd² |
| | | 1Ah | square foot | ft² |
| | | 1Bh | square inch | in² |

Volume

| | | | | |
|---|---|---|---|---|
| Volume | 14h | 08h | cubic kilometer | km³ |
| (capacity) | | 0Bh | cubic meter | m³ |
| | | 0Dh | cubic centimeter | cm³ |
| | | 0Eh | cubic millimeter | mm³ |
| | | 16h | cubic mile | mi³ |
| | | 19h | cubic yard | yd³ |
| | | 1Ah | cubic foot | ft³ |
| | | 1Bh | cubic inch | in³ |
| | | 29h | hectoliter | hl |
| | | 2Ah | decaliter | dal |
| | | 2Bh | liter | l |
| | | 2Ch | deciliter | dl |
| | | 2Dh | centiliter | cl |
| | | 2Eh | milliliter | ml |
| | | 42h | barrel of oil | bo |
| | | 49h | gallon (US) | gal |
| | | 4Ah | quart (US) | qt |
| | | 4Bh | pint (US) | pt |
| | | 4Dh | fluid ounce (US) | fl. oz. |
| | | 59h | imperial gallon | gal |
| | | | (UK) | |
| | | 5Ah | quart (UK) | qt |
| | | 5Bh | pint (UK) | pt |
| | | 5Dh | fluid ounce (UK) | fl. oz. |
| | | 69h | dry gallon | gal |
| | | 6Ah | dry quart | quart |
| | | 6Bh | dry pint | pt |

Mass

| | | | | |
|---|---|---|---|---|
| Mass | 18h | 07h | megagram (tonne) | Mg (t) |
| | | 08h | kilogram | kg |
| | | 0Bh | gram | g |
| | | 0Dh | centrigram | cg |
| | | 0Eh | milligram | mg |
| | | 0Fh | microgram | μg |
| | | 21h | long ton (UK) | t |
| | | 22h | short ton (UK) | t |
| | | 23h | pound | lb |
| | | 24h | ounce | oz |

Time

| | | | | |
|---|---|---|---|---|
| Time | 2Fh | 0Bh | second | s |
| | | 0Dh | centisecond | cs |
| | | 0Eh | millisecond | ms |
| | | 0Fh | microsecond | μs |
| | | 10h | nanosecond | ns |
| | | 11h | picosecond | pS |
| | | 12h | femtosecond | fs |
| | | 1B | year | yr |
| | | 1A | month | mo |
| | | 19 | day | d |
| | | 18 | hour | h |
| | | 17 | minute | min |

Frequency

| | | | | |
|---|---|---|---|---|
| Frequency | 34 | 04h | petahertz | PHz |
| | | 05h | terahertz | THz |
| | | 06h | gigahertz | GHz |
| | | 07h | megahertz | MHz |
| | | 08h | kilohertz | kHz |
| | | 0Bh | hertz | Hz |

Energy & Power

| | | | | |
|---|---|---|---|---|
| Energy | 58 | 6Bh | gigajoule | GJ |
| | | 07h | megajoule | MJ |
| | | 08h | kilojoule | kJ |
| | | 0Bh | joule | J |
| | | 21h | kilocalorie | kcal |
| | | 22h | calorie | cal |
| | | 45h | terawatt hour | TWh |
| | | 46h | gigawatt hour | GWh |
| | | 47h | megawatt hour | MWh |
| | | 48h | kilowatt hour | kWh |
| | | 4Bh | watt hour | Wh |
| | | 4Eh | milliwatt hour | mWh |
| Power | 5A | 06h | gigawatt | GW |
| | | 07h | megawatt | MW |
| | | 08h | kilowatt | kW |
| | | 0Bh | watt | W |
| | | 0Eh | milliwatt | mW |
| | | 0Fh | microwatt | pW |
| | | 31h | metric horsepower | hp |
| | | 32h | horsepower | hp |
| | | 33B | electric horsepower | hp |

Pressure & Stress

| | | | | |
|---|---|---|---|---|
| Pressure & | 50 | 07h | megapascal | Mpa |
| Stress | | 08h | kilopascal | kPa |
| | | 09h | hectopascal | hPa |
| | | 0Bh | pascal | Pa |
| | | 27h | megabar | Mbar |
| | | 28h | kilobar | kb |
| | | 2Bh | bar | b |
| | | 2Eh | millibar | mb |
| | | 48h | kilonewton per | kN/m² |
| | | | square meter | |
| | | 4Bh | newton per | N/m² |
| | | | square meter | |
| | | 60h | atmosphere | atm |
| | | 61h | pound per | psi |
| | | | square inch | |

Electric Parameters

| | | | | |
|---|---|---|---|---|
| Electric | 68 | 07h | megaohm | mΩ |
| Resistance | | 08h | kiloohm | kΩ |
| | | 0Bh | ohm | Ω |
| | | 0Eh | calorie | mΩ |
| Electric | 69 | 0Bh | farad | F |
| Capacity | | 0Eh | millifarad | mF |
| | | 0Fh | microfarad | μF |
| | | 10h | nanofarad | nF |
| | | 11h | picofarad | pF |
| Electric | 6A | 0Bh | ampere | A |
| Current | | 0Eh | milliampere | mA |
| | | 0Fh | microampere | μA |
| Electric | 6B | 06h | kilowatt | kW |
| Potential | | 07h | watt | W |
| | | 08h | milliwatt | mW |
| | | 0Bh | microwatt | μW |
| | | 0Eh | metric horsepower | hp |
| | | 0Fh | horsepower | hp |

Luminous Intensity

| | | | | |
|---|---|---|---|---|
| Luminous | 74 | 0Bh | candela | cd |
| Intensity | | | | |

Temperature

| | | | | |
|---|---|---|---|---|
| Temperature | 78 | 0Bh | kelvin | K |
| | | 2Bh | celsius | ° C. |
| | | 2Dh | centicelsius | c° C. |
| | | 4Bh | fahrenheit | oF |

Miscellaneous

| | | | | |
|---|---|---|---|---|
| User-Defined | 80-BF | 00h . . . FFh | N/A | N/A |
| Reserved | C0-FF | 00h . . . FFh | N/A | N/A |

TABLE 3

| | |
|---|---|
| Token Name | Value |

General Tokens

| | |
|---|---|
| <END Token> | FFh |
| <Local V² Token> | 10h |
| <Remote V² Token> | 11h |
| <Const Token> | 15h |

IF Statement

| | |
|---|---|
| <IF Token> | 7Fh |
| <ELSEIF Token> | FAh |
| <ELSE Token> | FBh |

Logical Expressions

| | |
|---|---|
| <NOT Token> | F9h |
| <AND Token> | F0h |
| <OR Token> | F1h |
| <XOR Token> | F2h |

Relational Expressions

| | |
|---|---|
| <GTE Token> | F3h |
| <GT Token> | F4h |
| <LTE Token> | F5h |
| <LT Token> | F6h |
| <EQ Token> | F7h |
| <NEQ Token> | F8h |

TRUE, FALSE

| | |
|---|---|
| <TRUE Token> | 01h |
| <FALSE Token> | 00h |

Timers

| | |
|---|---|
| <Timer Running Token> | C5h |
| <Timer Expired Token> | C6h |
| <Disable Timer Token> | C0h |
| <Start Timer Token> | C1h |

V² Actions

| | |
|---|---|
| <Assign Token> | 20h |
| <Add Token> | 21h |
| <Subtract Token> | 22h |
| <Multiply Token> | 23h |
| <Divide Token> | 24h |
| <Force Report Token> | 26h |

Value Types

| | |
|---|---|
| <Boolean Token> | 00h |
| <Unsigned Char Token> | 01h |
| <Signed Integer Token> | 02h |
| <Signed Long Token> | 03h |
| <Float Token> | F4h |
| <Data Token> | F5h |

Miscellaneous

| | |
|---|---|
| <Value Changed Token> | B0h |
| <50 ms Token> | C7h |
| <Clear Settings Token> | 25h |

What is claimed is:

1. A method for configuring and controlling a plurality of interconnected electronic devices defining a network, said method comprising:
a) selecting at least one of said plurality of electronic devices as a local node;
b) defining at least one local virtual variable having a value representative of a state of said local node;
c) defining the non-selected devices as remote nodes; each remote node having at least one remote virtual variable having a value representative of a state thereof, each said remote virtual variable being reported on said network when predetermined conditions are met.
d) providing said local node with at least one action using said local virtual variable and said remote virtual variable;
e) executing said action in response to said reporting of said remote virtual variable, said action changing said value of said local virtual variable; and
f) modifying said state of said local node according to said value of said local virtual variable.

2. A method according to claim 1, wherein said local variable defining act and remote variable defining act include defining variable values having an associated type, said type belonging to a set including: boolean, unsigned character, signed integer, signed long and float.

3. A method according to claim 1, wherein said action includes assigning said remote virtual variable to said local virtual variable.

4. A method according to claim 3, wherein said assigning of said remote virtual variable to said local virtual variable does not require said remote variable value to be of the same type as said local variable value.

5. A method according to claim 1, wherein the reporting condition includes that said value of said remote virtual variable has changed.

6. A method according to claim 1, wherein the reporting condition includes that a given time interval has elapsed since a previous reporting of said remote virtual variable.

7. A method according to claim 1, wherein the reporting condition includes that said value of said remote virtual variable has changed by a given delta.

8. A method according to claim 1, wherein the reporting condition includes that said value of said remote virtual variable has changed by a given ratio.

9. A method according to claim 1, wherein the act of executing said action is done by interpretation.

10. A method according to claim 1, wherein there is a further act of defining at least one additional local node virtual variable, said additional local node virtual variable being a remote virtual variable associated with said local node, said additional local node virtual variable being reported on said network in response to a certain reporting condition being satisfied.

11. A method according to claim 10, wherein there is a further act of defining at least one additional remote node virtual variable, said additional remote node virtual variable being a local virtual variable associated with said remote node.

12. A method according to claim 11, further comprising:
a) providing said remote node with at least one action using said additional remote node virtual variable and said additional local node virtual variable;
b) executing said action in response to said reporting of said additional local node virtual variable, said action changing said value of said additional remote node virtual variable; and
c) modifying said state of said remote node according to said value of said additional remote node virtual variable.

13. A network interconnecting a plurality of electronic devices for their configuration and control, said network comprising:
a) at least one of said plurality of electronic devices being a local node including a controller, a memory and at least one local virtual variable having a value representative of a state of said local node; said local virtual variable being stored in said memory of said local node;
b) the non-selected electronic devices being remote nodes including a controller and a memory, said memory having stored therein at least one remote virtual variable having a value representative of a state of said remote node, said remote virtual variable being reported by said controller of said remote node on said network when predetermined conditions are met; and
c) at least one action being stored in said memory of said local node for execution by said controller of said local node, the action using said local virtual variable and said remote virtual variable;
wherein said controller of said local node is so configured as to execute said action stored in said memory of said local node in response to the reporting of said remote virtual variable, said action changing said value of said local virtual variable and modifying said state of said local node according to said value of said local virtual variable.

14. A network according to claim 13, wherein said local variable and said remote variable values have an associated type, said type belonging to a set including: boolean, unsigned character, signed integer, signed long and float.

15. A network according to claim 13, wherein said action includes assigning said remote virtual variable value to said local virtual variable value in said memory.

16. A network according to claim 15, wherein said assigning of said remote virtual variable value to said local virtual variable value in said memory does not require said remote variable value to be of the same type as said local variable value.

17. A method according to claim 13, wherein the reporting condition includes that said value of said remote virtual variable has changed.

18. A network according to claim 13, wherein the reporting condition includes that a given time interval has elapsed since a previous reporting of said remote virtual variable.

19. A network according to claim 13, wherein the reporting condition includes that said value of said remote virtual variable has changed by a given delta.

20. A network according to claim 13, wherein the reporting condition includes that said value of said remote virtual variable has changed by a given ratio.

21. A network according to claim 13, wherein said action is part of an interpreted programming language.

22. A network according to claim 13, wherein said memory of said local node having stored therein at least one additional remote virtual variable associated with said local node, said additional remote virtual variable being reported by said controller of said local node on said network when predetermined conditions are met.

23. A network according to claim 22, wherein said memory of said remote node having stored therein at least one additional local virtual variable associated with said remote node, said additional local virtual variable being reported by said controller of said remote node on said network when predetermined conditions are met.

24. A network according to claim 23, further comprising at least one action being stored in said memory of said remote node for execution by said controller of said remote node, the action using said additional local virtual variable and said additional remote virtual variable, wherein said controller of said local node is so configured as to execute said action in response to said reporting of said additional remote virtual variable, said action changing said value of said additional local virtual variable and modifying said state of said remote node according to said value of said additional local virtual variable.
